(19) United States
(12) Patent Application Publication
(10) Pub. No.: US 2008/0201312 A1
(43) Pub. Date: Aug. 21, 2008

(54) SYSTEMS AND METHODS FOR A DEVICESQL PARALLEL QUERY

(75) Inventor: David Posner, Napa, CA (US)

Correspondence Address: BAKER & MCKENZIE LLP;PATENT DEPARTMENT, 2001 ROSS AVENUE, SUITE 2300, DALLAS, TX, 75201, US

(73) Assignee: ENCIRQ CORPORATION, Burlingame, CA (US)

(21) Appl. No.: 12/016,000

(22) Filed: Jan. 17, 2008

Related U.S. Application Data
(60) Provisional application No. 60/885,334, filed on Jan. 17, 2007.

(51) Int. Cl. G06F 17/30

(52) U.S. Cl. 707/4; 707/E17.14

(57) ABSTRACT

A system for parallel processing of a database query in a multi-core processor is disclosed. The system includes a core database instance and a main database instance. The core database instance includes a local storage manager, a local page manager, and a core stream processing component. The local storage manager is configured to convert a record request into a page request. The local page manager is communicatively connected to the local storage manager and is configured to receive and route the page request. The core stream processing component is communicatively connected to the local storage manager and is configured to send a record request to the local storage manager, process a record stream received from the local storage manager and output a processed record stream.

### APPLICATION FOR CLAIM OF PRIORITY

This application claims the benefit under 35 U.S.C. § 119(e) of U.S. Provisional Application No. 60/885,334 filed Jan. 17, 2007. The disclosure of the above-identified application is incorporated herein by reference as if set forth in full.

### BACKGROUND

1. Field

The embodiments described herein relate to data processing, and more particularly to fast parallel data processing using stream processing techniques.

2. Background

Perhaps the most significant processing bottleneck for conventional processor technologies is memory latency. Access to an uncached memory location costs many hundreds of processor cycles. This is partly due to the physics of dynamic memory and partly due to the overhead in modern systems of memory mapping and address translation. Efforts to diminish this bottleneck have focused on on-chip memory cache(s) and complex logic with compiler support for “speculative pre-fetching” in which the chip guesses which way conditional branches are going to go and fetches code and data into the cache(s).

There are heuristics for guessing, e.g., what backward branching as in loops are likely to be taken, and there are mechanisms, e.g., like pragmas, that can allow a programmer to annotate branches assuming he knows how to do so. It has been shown, however, that processing gains using such techniques have more or less been fully exploited and that after a few branch levels the returns are not justified by the added complexity in chip logic. It should be noted that certain programming practices considerably exacerbate processing bottlenecks. For example, object oriented programs spread data throughout memory in highly unpredictable ways and significantly reduce the effectiveness of memory caching. Context switching a processor (e.g., multi-processing and/or multi-threading) is generally catastrophic for these purposes, because, it completely invalidates the memory caches and swapping threads is likely to force most of the cached data (certainly cached code) to be irrelevant.

IBM created one potential solution to address the challenges that are discussed above. The solution is called the Cell Broadband Engine chip (i.e., Cell BE chip). The Cell BE architecture is a radical departure from traditional processor designs. The Cell BE processor is a multi-processor chip consisting of nine processing elements. The main processing element is a fairly standard general-purpose processor. It is a dual-core PowerPC®-based element, called the Power Processing Element (PPE).

The other processing elements within the Cell BE are known as Synergistic Processing Elements (SPE). Each SPE consists of: A vector processor, called a Synergistic Processing Unit (SPU), a private memory area within the SPU called the local memory store, a set of communication channels for dealing with the outside world, a set of registers (each 128 bits wide), where each register is normally treated as holding four 32-bit values simultaneously, and a Memory Flow Controller (MFC) that manages Direct Memory Access (DMA) transfers between the SPU's local memory store and the main memory.

The SPEs, however, lack most of the general-purpose features that you normally expect in a processor. They are fundamentally incapable of performing normal operating system tasks. They have no virtual memory support, do not have direct access to the computer's random access memory (RAM), and have extremely limited interrupt support. These processors are wholly concentrated on processing data as quickly as possible.

Therefore, the PPE acts as the resource manager, and the SPEs act as the data processors. Programs on the PPE divvy up tasks to the SPEs to accomplish, and then data is fed back and forth to each other.

Connecting together the SPEs, the PPE, and the main memory controller is a bus called the Element Interconnect Bus. This is the main passageway through which data travels.

Each SPE's 256 Kb local memory store is not a cache. Rather, it is actually the full amount of memory that an SPE has to work with for both the data processing application and the data. This affords several advantages: 1) access to the local memory store are extremely fast compared to access to main memory, 2) accesses to local memory store can be predicted down to the clock cycle, and 3) moving data in and out of main memory can be requested asynchronously and predicted ahead of time. Basically, it has all of the speed advantages of a cache. However, since programs use it directly and explicitly, they can be much smarter about how it is managed. It can request data to be loaded in before it is needed, and then go on to perform other tasks while waiting for the data to be loaded.

Consequently, the total extent of programming code and the data running in an SPU task has to be less than or equal to 256 Kb. If it wants to access data (fetch or store) not in its local memory store, it must issue commands to a memory controller with the effective address in general memory and address in local store. These commands are called “Direct Memory Access” (DMA) commands.

A difference between the IBM solution and the older code and data “overlays” is that the SPU can issue multiple DMA commands (up to 16) that run in parallel with the processor so that the program can do its own pre-fetching and post-storing. The downside is that the data must be copied into and out of the local memory store to be used by the processor. The performance cost of this copying can be lessened by arranging for copies into and out of the local occur in parallel with the processing in the core. This can even result in performance improvements because memory in the local store is faster than main memory.

So the name of the game in SPU programming is double buffering. One buffer is loading (storing), while the other is being processed (filled), and then they are swapped. In order to make use of this effectively the programmer has to be able to partition the data into 256 Kb size chunks. Basically the SPUs can be treated as 8×256 Kb vector machines. The data chunks are submatrices and the code chunks are just matrix operations. Virtually all the existing applications of the Cell BE are based on this, e.g., graphics, signal processing, image processing, and scientific programming. However, this does not apply to data processing.

To apply to data processing the data needs to be carved out into discrete chunks. Relational databases are therefore promising because the data is pre-chunked into rows (i.e., records) and pages of rows. The challenge is that, typical database processing applications cannot be effectively chunked to run on SPEs because they tend to be fairly large.

### SUMMARY

Systems and methods for parallel processing of a database query on a multi-core processor are disclosed.

In one aspect, a system for parallel processing of a database query in a multi-core processor is disclosed. The system includes a core database instance and a main database instance. The core database instance includes a local storage manager, a local page manager, and a core stream processing component. The local storage manager is configured to convert a record request into a page request. The local page manager is communicatively connected to the local storage manager and is configured to receive and route the page request. The core stream processing component is communicatively connected to the local storage manager and is configured to send a record request to the local storage manager, process a record stream received from the local storage manager and output a processed record stream.

The main database instance includes a global page manager, a main stream processing component and a main record storage manager. The global page manager is communicatively connected to the local page manager and an external storage device and is configured to receive page requests from the local page manager, retrieve the requested page from the external storage device, and send the requested page back to the local page manager. The main stream processing component is configured to aggregate one or more processed record streams into a consolidated record stream. The main record storage manager is communicatively connected to the main stream processing component and the global page manager and is configured to receive the consolidated record stream from the main stream processing component, convert the consolidated record stream into a consolidated page and forward the consolidated page to the global page manager.

In another aspect, a method for compiling a database query to operate on a multi-core processor is disclosed. The query logic is defined for the database query. The database query is compiled into a main database instance configured to be deployed and independently run on a main processing unit and a core processing unit. The main database instance is loaded to the main processing unit. The core database instance is loaded to the core processing unit. The main database instance and the core database instance are then initiated.

In still another aspect, a method for parallel processing of a database query on a multi-core processor is disclosed. A record request is sent from a core stream processing component to a local storage manager. The record request is converted into a page request. The page request is sent to a local page manager where the page request is then forwarded to a global page manager on a main database instance. The requested page is retrieved from an external storage that is communicatively connected to the main database instance. The requested page is sent to the local page manager which forwards the requested page to the local record storage manager. The requested page is then converted into a record stream. The record stream is sent to the core stream processing component where it is processed into a processed record stream. The processed record stream is output to a main stream processing component on the main database instance.

These and other features, aspects, and embodiments of the invention are described below in the section entitled “Detailed Description.”

### BRIEF DESCRIPTION OF THE DRAWINGS

For a more complete understanding of the principles disclosed herein, and the advantages thereof, reference is now made to the following descriptions taken in conjunction with the accompanying drawings, in which:

FIG. 1 is an illustration of a system for parallel processing of a database query on a multi-core processor, in accordance with one embodiment.

FIG. 2 is a diagram illustrating an example process for compiling a database query to operate on a multi-core processor, in accordance with one embodiment.

FIG. 3 is a diagram illustrating an example process for parallel processing of a database query on a multi-core processor, in accordance with one embodiment.

### DETAILED DESCRIPTION

Systems and methods for parallel processing of data queries are disclosed. It will be obvious, however, that the present embodiments may be practiced without some or all of these specific details. In other instances, well known process operations have not been described in detail in order not to unnecessarily obscure the present embodiments.

As used herein, a multi-core processor is an integrated circuit (IC) chip that includes a main central processing unit (CPU) processor and one or more core CPU processors that are configured to operate independently to process instructions and/or data in parallel. Using this architecture, separate core processors can be equipped with small but fast local memory stores. Examples of multi-core processors, include but are not limited to the, IBM CELL BE™ processor, AMD ATHLON X2™ and Intel CORE DUO™, etc. A database is a collection of records or information which is stored in a conventional computing device in a systematic (i.e. structured) way so that a user can consult it to answer queries. Examples of the types of data structures that are used by databases to store information include: arrays, lists, trees, graphs, etc. A database instance is a software object that is an instantiation of a database application. The database instance may share some or all the properties of the database application that it is based off of.

The various embodiments, described herein, relate to database applications that can be utilized in a multi-core processor architecture to provide parallel data processing, thus, taking full advantage of the multi-core processor architecture.

A key programming problem for developers of database applications that exploit the multi-core processor architecture is the management of code and data within the local memory store allocated to each of the core processors. To fully exploit this feature a database application can: 1) partition the application into component tasks which can run independently and completely (including code and data) within the local memory store associated with each core processor, and 2) ensure that loading and storing of data overlays into and out of the local memory store runs concurrently with database processing so that the cost in throughput due to copying and storing is minimal or zero.

The partitioning of the database application can be accomplished through the use of a database compiler that can be configured to create a modified database application that is customized for a particular set of operations (query logic) that are specified in advance. As such, the database instances that are instantiated off of the modified database application includes only the minimum services and components that are referenced in the database compiler. Through this optimization, the database instances can be sized to be less than the memory size of the memory stores associated with the main processor and core processor(s). Generally, a separate main database instance is instantiated to run independently on the main CPU processor while a separate core database instance is instantiated to run independently on the core CPU processor.

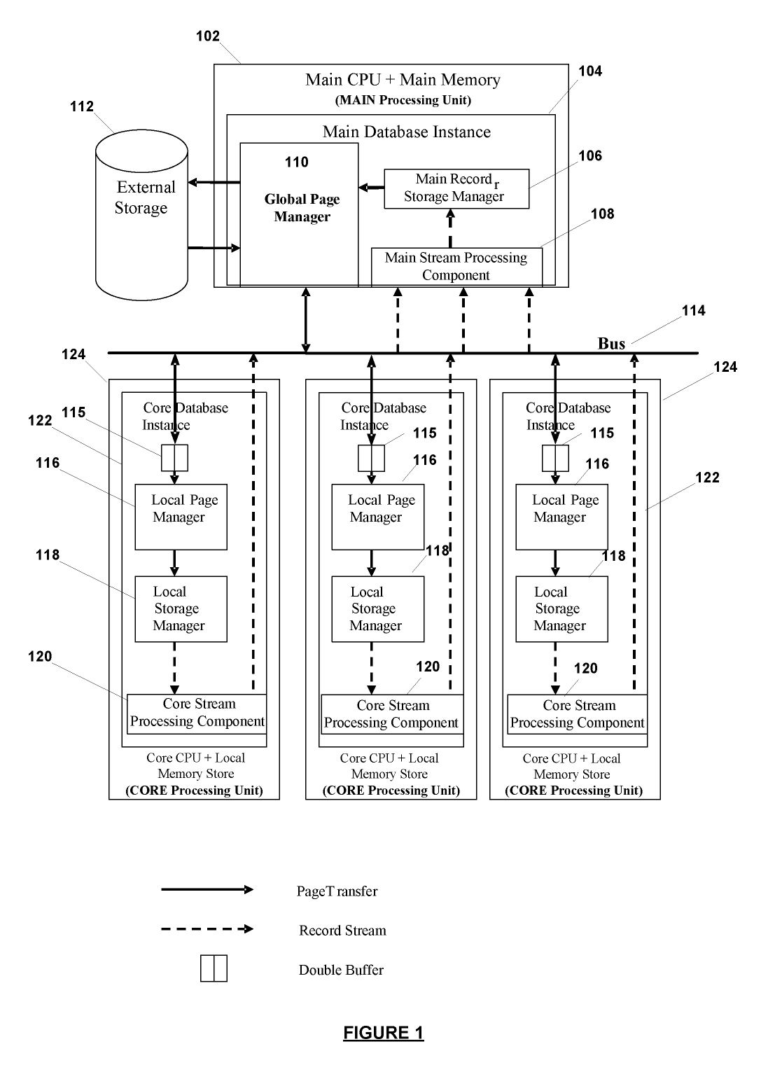

FIG. 1 is an illustration of a system for parallel processing of a database query in a multi-core processor, in accordance with one embodiment.

As depicted herein, the multi-core database processing system 100 can include a main processing unit 102, an external storage unit 112, a bus 114, and one or more core processing units 124. The main processing unit 102 can be communicatively connected to the one or more core processing units 124 via the bus 114. The external storage unit 102 can be communicatively connected to the main processing unit via a local area network (LAN) or a wide area network (WAN) connection. The external storage unit 102 can be any conventional data storage device, e.g., a network data server, an external hard drive, an external tape drive, etc.

The main processing unit 124 can be communicatively connected to a main memory store and can be configured to run a main database instance 104 that can be partitioned out of the database application being run on the multi-core processor. The main database instance 104 can include a global page manager 110, a main record storage manager 106 and a main stream processing component 108. Generally, the size of the main database instance 104 is less than the size of the main memory store.

The core processing unit 124 can be communicatively connected to a local memory store and can be configured to run a core database instance 122 that can be partitioned out of the database application being run on the multi-core processor. The core database instance 122 can include a buffering element 115, a local page manager 116, a local storage manager 118, and a core stream processing component 120. Generally, the size of the core database instance 122 is less than the size of the local memory store.

Using this parallel processing system architecture, there can be absolute separation and abstraction of functions concerned with the processing of records from the functions concerned with storage and retrieval of rows from or to a table or other data source. The abstraction (software object) configured for storage and retrieval is generally termed a “Record Storage Manager” (i.e., main record storage manager 106 and local storage manager 118). The abstraction concerned with creation, modification, and mapping into of pages into memory is generally called a “Page Manager” (i.e., global page manager 110 and the local page manager 116). As used herein, a page can be comprised of one or more records. The component concerned with the processing of a record stream is generally termed the “Stream Processor” (i.e., main stream processing component 108 and the core stream processing component 120). The separation and abstraction of various functions allow the compilation of specialized data processing applications into stand-alone programs with very small footprints that permit parallel processing of multiple record streams.

For example in a non-parallelized database query the flow of data is:

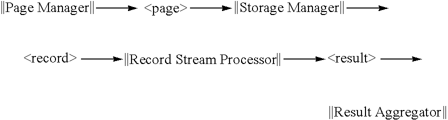

Here an abstract “Result Aggregator” can be configured to do whatever the application wants done with the results. For, example, if the results are in turn records which are to be stored in a page managed table then the flow would look like:

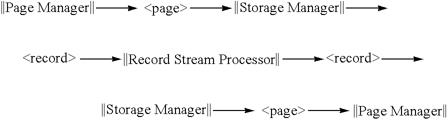

As depicted in FIG. 1, this process can be parallelize by creating multiple instances of the Record Stream processor (i.e., main stream processing component 108 and the core stream processing component 120) to run on separate processors (i.e., main processing unit 102 and core processing unit 124) and configure the initial Page Manager (i.e., the Global Page Manager 110) so that it can distribute the pages across the different instances (i.e., core database instance 122) and configure the Result Aggregator so that it can gather and aggregate multiple streams of results.

So that the flow of data in a database query becomes:

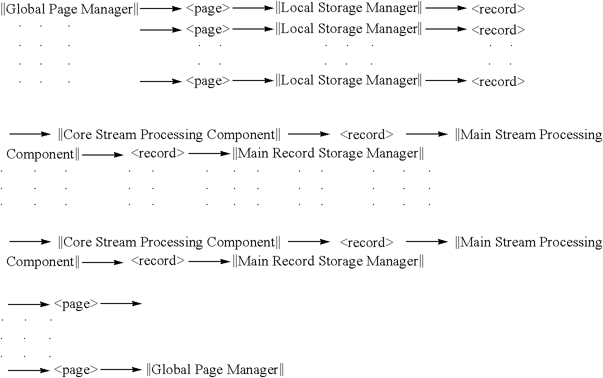

In one embodiment, the Result Aggregator can be integrated with the main stream processor to form main stream processing component 108. In another embodiment, the Result Aggregator can be a standalone software object that operates independently of the main stream processor.

Furthermore, to allow the individual core processing units to operate independently and in a parallel query, the core database instances can be configured to have the following data communication capabilities:

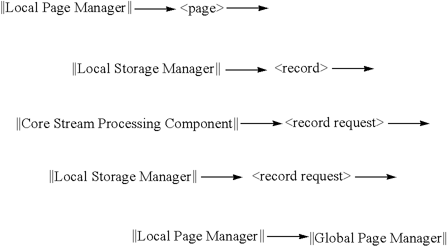

Here the local page manager 116 can be configured to be a special page manager running in the local store of the core processing unit 124 that functions as a proxy for the global page manager 110 (i.e., the page manager that can access all the pages associated with the query). The local page manager 116 and the global page manager 110 can communicate control page requests via the core processing unit 124 mailbox channels and pass page data via direct memory access (DMA) requests which are double buffered (i.e., buffering element 115) so that copying and storing of page data can be handled concurrently with the record processing.

That is, using the system architecture depicted in FIG. 1, the management of record storage, management of page storage and processing of record streams can become wholly abstract and separable components. The local page manager 116 of the core database instance 122 can use an abstract page manager application programming interface (API) to fetch pages (by way of page requests) directly from the global page manager 110. The global page manager 110 is responsible for interacting with the external storage device 112. Because the source of the pages is irrelevant to the local storage manager 118, it can be configured to convert those pages into record streams which are fed to the core stream processing component 120 which can be configured to execute query logic to process the record stream to produce a processed record stream as an output. The processed record stream output from the core stream processing component 120 can be directed back to the main stream processing component 108 that is part of the main database instance 104. The main stream processing component 108 can be configured to aggregate the processed record streams received from the one or more core stream processing components 120 running on the one or more core processing units 124 into a single aggregated record stream. The single aggregated record stream can be directed to the main record storage manager 106 where it can be converted into pages that are fed to the global page manager 110 to be stored/archived in an external storage device 112.

In one embodiment, the relationship between the local page manager 116 and the global page manager 110 can be as depicted below.

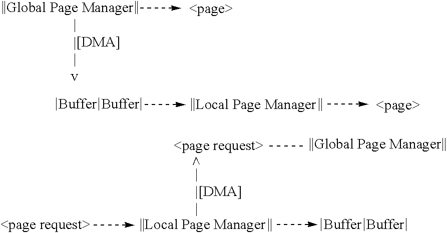

It should be understood, however, that the local page manager 116 can interact with the global page manager 110 using communication pathways and methods that are different than those described in the above embodiment, as long as they can be executed on a multi-core processor architecture.

Furthermore, it should be appreciated that this same system of parallelizing data processing applications can be applied to any type of database system and data sources created using any technology. For example, this would enable parallelization of data base operations in the context of any relational database engine such as DB2, Oracle, Sybase, etc. and of stream processing systems like that provided by StreamBase.

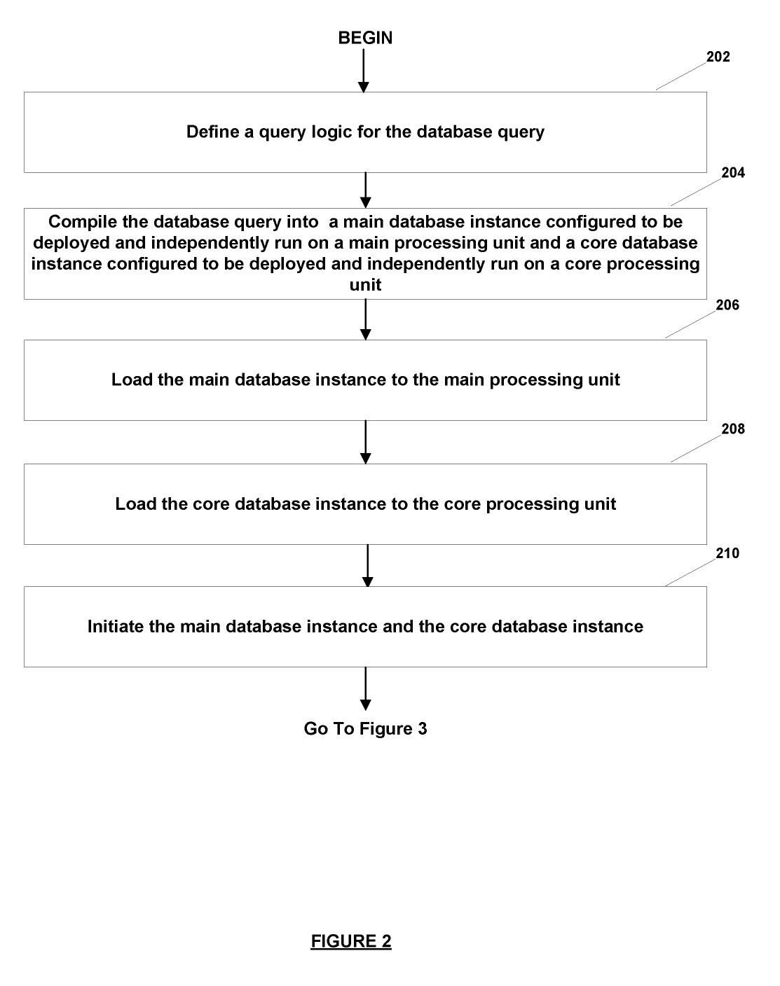

FIG. 2 is a diagram illustrating an example process for compiling a database query to operate on a multi-core processor, in accordance with one embodiment.

As depicted herein, in step 202 a query logic is defined for the database query. As discussed above, the query logic includes only the minimum services and components that are specified in advance to be included in the database query. In step 204, a database compiler compiles the database query into a main database instance that can be configured to be deployed and independently run on a main processing unit and a core database instance that can be configured to be deployed and independently run on a core processing unit. The database instances that are instantiated off of the compiled database application includes only the minimum services and components that are referenced in the query logic. As such, the database instances can be sized to be less than the local memory stores (i.e., main memory store and local memory store) of the processors (main processor and core processor) used to run them.

The method proceeds on to steps 206 and 208 where the main database instance is loaded on to the main processing unit and the core database instance is loaded on to the core processing unit(s) where they are initiated in step 210. It should be understood, however, that order in which the main database instance and core database instance are loaded on to the main processing unit and core processing unit(s) can be reversed or staggered as long as it does not adversely effect the operation of the parallel processing of the database query.

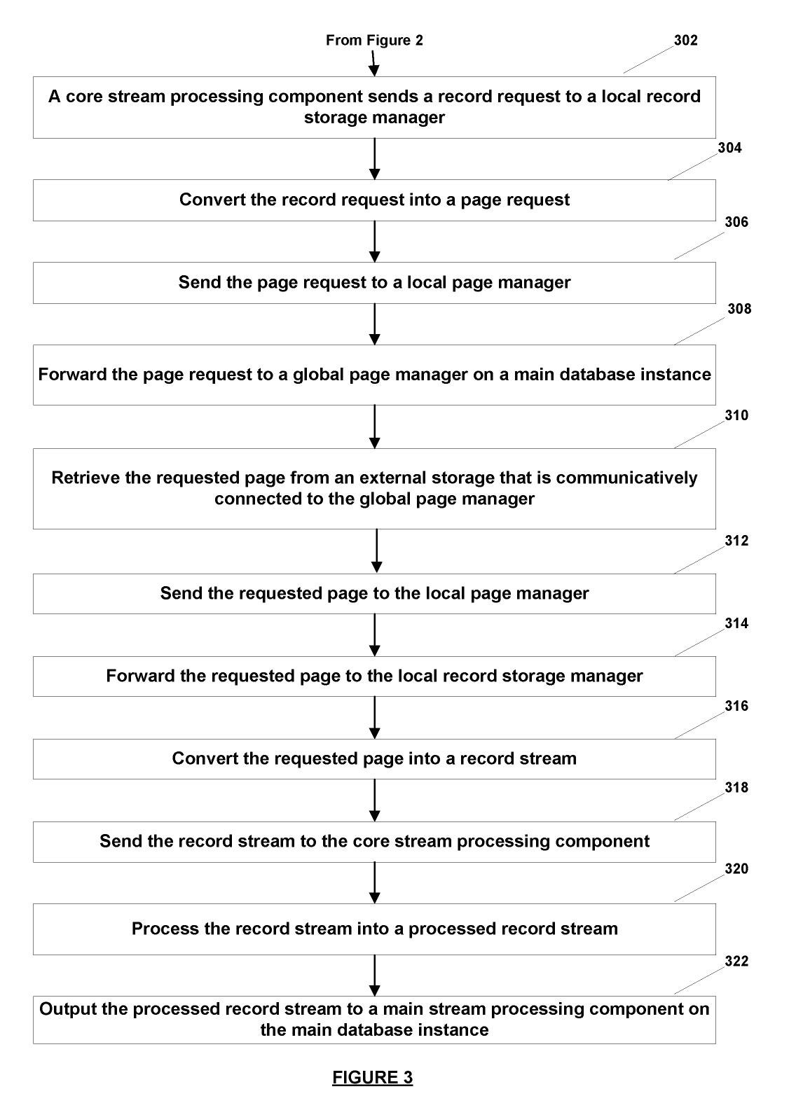

FIG. 3 is a diagram illustrating an example process for parallel processing of a database query on a multi-core processor, in accordance with one embodiment. As shown herein, the method begins with step 302 where a core stream processing component (that can be an element of a core database instance) can send a record request to a local record storage manager. In step 304, the local record storage manager can convert the record request into a page request. In step 306, the page request can be sent to a local page manager, which can proceed to forward the page request to a global page manager on a main database instance in step 308. The local page manager can be configured to be communicatively connected to the global page manager via a bus on the IC that houses the main processing unit and core processing unit running the main database instance and core database instance. In step 310, the requested page can be retrieved from an external storage that is communicatively connected to the global page manager. As discussed above, the global page manager can communicate with the external storage device via a local area network (LAN) or a wide area network (WAN) connection. Also, the external storage device can be any conventional data storage device, e.g., a network data server, an external hard drive, an external tape drive, etc.

Proceeding on to step 312, the requested page can be sent to the local page manager. In step 314, the requested page is forwarded from the local page manager to the local storage manager where the requested page can be converted by the local storage manager into a record stream in step 316. In step 318, the record stream is sent to the core stream processing component 318. In step 320, the core stream processing component processes the record stream into a processed record stream. In step 322, the processed record stream is output to a main stream processing component on the main database instance.

As discussed above, the main stream processing component is configured to aggregate the one or more processed record streams received from the one or more core database instances into a consolidated processed record stream. The consolidated record stream can be sent to a main record storage manager, where it is converted into a consolidated paged. The consolidated page can then be sent to the global page manager which can be configured to store the consolidated page at an external storage device, e.g., a network data server, an external hard drive, an external tape drive, etc.

Any of the operations that form part of the embodiments described herein are useful machine operations. The invention also relates to a device or an apparatus for performing these operations. The systems and methods described herein can be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The embodiments described herein can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed is:

1. A system for parallel processing of a database query in a multi-core processor, comprising:
a core database instance, including,
a local storage manager configured to convert a record request into a page request,
a local page manager communicatively connected to the local storage manager, the local page manager configured to receive and route the page request, and
a core stream processing component communicatively connected to the local storage manager, the core stream processing component configured to send a record request to the local storage manager, process a record stream received from the local storage manager and output a processed record stream; and
a main database instance, including,
a global page manager communicatively connected to the local page manager and an external storage device, wherein the global page manager is configured to,
receive page requests from the local page manager,
retrieve the requested page from the external storage device, and
send the requested page back to the local page manager,
a main stream processing component configured to aggregate one or more processed record streams into a consolidated record stream, and
a main record storage manager communicatively connected to the main stream processing component and the global page manager, the main record storage manager configured to,
receive the consolidated record stream from the main stream processing component,
convert the consolidated record stream into a consolidated page, and
forward the consolidated page to the global page manager.

2. The system for parallel processing of a database query in a multi-core processor, as recited in claim 1, wherein the multi-core processor is comprised of a main processing unit configured to operate in conjunction with one or more core processing units to parallel process the database query.

3. The system for parallel processing of a database query in a multi-core processor, as recited in claim 1, wherein the page is comprised of one or more records.

4. The system for parallel processing of a database query in a multi-core processor, as recited in claim 1, wherein the external storage device is a data storage server.

5. The system for parallel processing of a database query in a multi-core processor, as recited in claim 1, wherein the global page manager is further configured to send the consolidated page to the external storage device for storage.

6. The system for parallel processing of a database query in a multi-core processor, as recited in claim 1, wherein the core database instance is run on a core processing unit.

7. The system for parallel processing of a database query in a multi-core processor, as recited in claim 1, wherein the core processing unit is a synergistic processing element (SPE).

8. The system for parallel processing of a database query in a multi-core processor, as recited in claim 6, wherein the core processing unit is comprised of a core CPU processor and a local memory storage.

9. The system for parallel processing of a database query in a multi-core processor, as recited in claim 8, wherein the size of the core database instance is less than the size of the local memory storage.

10. The system for parallel processing of a database query in a multi-core processor, as recited in claim 1, wherein the main database instance is run on a main processing unit.

11. The system for parallel processing of a database query in a multi-core processor, as recited in claim 10, wherein the main processing unit is comprised of a main CPU processor and a main memory storage.

12. The system for parallel processing of a database query in a multi-core processor, as recited in claim 11, wherein the size of the main database instance is less than the size of the main memory storage.

13. The system for parallel processing of a database query in a multi-core processor, as recited in claim 1, wherein the size of the page is less than the size of the local memory cache.

14. A method for compiling a database query to operate on a multi-core processor, comprising:
defining the query logic for the database query;
compiling the database query into a main database instance configured to be deployed and independently run on a main processing unit and a core database instance configured to be deployed and independently run on a core processing unit;
loading the main database instance to the main processing unit;
loading the core database instance to the core processing unit; and
initiating the main database instance and the core database instance.

15. The method for compiling a database query instance to operate on a multi-core processor, as recited in claim 14, wherein the query logic includes a set of query operations.

16. The method for compiling a database query instance to operate on a multi-core processor, as recited in claim 14, wherein the core processing unit is configured to operate in conjunction with the main processing unit to parallel process the database query.

17. A method for parallel processing of a database query on a multi-core processor, comprising:
a core stream processing component, sending a record request to a local storage manager;
converting the record request into a page request;
sending the page request to a local page manager;
forwarding the page request to a global page manager on a main database instance;
retrieving a requested page from an external storage that is communicatively connected to the global page manager;
sending the requested page to the local page manager;
forwarding the requested page to the local record storage manager;
converting the requested page into a record stream;
sending the record stream to the core stream processing component;
processing the record stream into a processed record stream; and
outputting the processed record stream to a main stream processing component on the main database instance.

18. The method for parallel processing of a database query on a multi-core processor, as recited in claim 17, wherein the multi-core processor is comprised of a main processing unit configured to operate in conjunction with one or more core processing units.

19. The method for parallel processing of a database query on a multi-core processor, as recited in claim 17, wherein the requested page is comprised of one or more records.

20. The method for parallel processing of a database query on a multi-core processor, as recited in claim 17, wherein the external storage device is a data storage server.

21. The method for parallel processing of a database query on a multi-core processor, as recited in claim 17, further including:
aggregating one or more processed record streams into a consolidated processed record stream;
sending the consolidated processed record stream to a main record storage manager;
converting the consolidated processed record stream into a consolidated page;
sending the consolidate page to a global page manager; and
storing the consolidated page at the external storage.

22. The method for parallel processing of a database query on a multi-core processor, as recited in claim 21, wherein the consolidated page is a table of processed records.
